(19) United States
(12) Patent Application Publication
(10) Pub. No.: US 2025/0235730 A1
(43) Pub. Date: Jul. 24, 2025

(54) METHOD FOR PRODUCING A FIREFIGHTING MEDIUM FROM WATER AND LIQUID GAS, A FIRE EXTINGUISHER AND A METHOD FOR EXTINGUISHING A FIRE WITH THE FIREFIGHTING MEDIUM

(71) Applicant: Svante Syk, Hova (SE)

(72) Inventor: Svante Syk, Hova (SE)

(21) Appl. No.: 18/849,217

(22) PCT Filed: Mar. 21, 2023
(86) PCT No.: PCT/EP2023/057146

§ 371 Date: Sep. 20, 2024

(30) Foreign Application Priority Data
Mar. 22, 2022 (SE) 2230084-2

(51) Int. Cl. A62C 5/02; A62C 5/00; A62C 31/00; A62C 31/12; A62C 99/00

(52) U.S. Cl. CPC A62C 5/024; A62C 5/002; A62C 5/008; A62C 31/005; A62C 31/12; A62C 99/0027

(57) ABSTRACT

A method for producing a firefighting medium from water (W) and a liquefied gas, such as liquid nitrogen (LN) or liquid carbon dioxide, a fire extinguisher (200) for extinguishing a fire with the produced firefighting medium, and a method for extinguishing a fire with the produced firefighting medium, wherein the firefighting medium (FFM) is produced by spraying a pressurized jet of water (WJ) out of a nozzle (201) at a pressure of, for instance, at least 50 bar and mixing a proportion of liquid nitrogen (LN) into the jet of water (WJ).

### TECHNICAL FIELD

The present invention relates to a method for producing a firefighting medium from water and a liquid gas, such as liquid nitrogen (LN) or liquid carbon dioxide, a fire extinguisher for extinguishing a fire with the firefighting medium, and a method for extinguishing a fire with the firefighting medium.

### BACKGROUND OF THE INVENTION

It is previously known that inert gases such as liquid nitrogen can be used in firefighting applications. For instance, patent publication CN103071264A discloses a firefighting truck which, in one embodiment, comprises both an insulated water storage tank and a high-pressure gas storage of liquid nitrogen and helium, so that water in combination with inert gas can be used as a firefighting medium for fire extinguishing.

However, the present inventor has found that there is a need for further improvement of the efficiency and reliability of the present methods, mediums and equipment for firefighting using water in combination with liquid nitrogen or other liquid gas suitable for firefighting.

### SUMMARY OF THE INVENTION

A first object of the present invention is therefore to provide an improved method for producing a firefighting medium from water and a liquid gas, such as liquid nitrogen (LN) or liquid carbon dioxide.

This first object is achieved by means of a method according to claim 1, wherein the firefighting medium is produced by spraying a pressurized jet of water out of a nozzle at a pressure of, for instance, at least 50 bar and mixing a proportion of liquid gas into the jet of water.

The firefighting medium produced by the above-mentioned method will have a very high fire extinguishing efficiency for several reasons. The liquid gas causes water droplets in the pressurized jet of water to become supercooled and freeze to ice so that ice crystals or particles are formed in the produced firefighting medium. The ice crystals or particles help the water in the firefighting medium to reach the seat of fire where the crystals or particles act by cooling the hot fire and excluding oxygen. The liquid gas mixed into the water is very cold and produces a great cooling effect when evaporated. Furthermore, the ice crystals or particles present in the firefighting medium will increase the effective extinguishing distance when firefighting. A suitable liquid gas is liquid nitrogen.

A second object of the present invention is to provide an improved fire extinguisher for extinguishing a fire with a firefighting medium produced from water and liquid gas.

This second object is achieved by means of a fire extinguisher according to claim 9, wherein the fire extinguisher comprises fire extinguishing means adapted to allow it to extinguish the fire by directing a jet of a firefighting medium produced by the method for producing a firefighting medium according to the invention onto the fire.

The above-mentioned fire extinguisher enables reliable and highly efficient firefighting while making use of the already described advantages provided by the firefighting medium produced by the method for producing a firefighting medium according to the invention.

A third object of the present invention is to provide an improved method for extinguishing a fire with a firefighting medium produced from water and liquid gas.

This third object is achieved by means of a method according to claim 13, wherein said fire is extinguished by directing a jet of a firefighting medium produced by the method for producing a firefighting medium according to the invention onto said fire.

The above-mentioned method for extinguishing a fire enables highly efficient firefighting while making use of the already described advantages provided by the firefighting medium produced by the method for producing a firefighting medium according to the invention.

Further objects and advantages of the invention, and the features enabling these objects and advantages to be achieved, will become evident from the following description.

In further aspects of the invention it should be noted that the jet of the “firefighting medium” is not useful only for firefighting but also for e.g. cooling of objects (which may or may not be a fire fighting measure). This means, for instance, that expressions like “method for producing a firefighting medium from water and liquid nitrogen” used in this disclosure should be interpreted as a method for producing a firefighting and/or cooling medium from water and liquid nitrogen (or other suitable substance, such as liquid carbon dioxide). Further, the expression “fire extinguisher for extinguishing a fire with a firefighting medium produced from water and liquid nitrogen” should be interpreted as a device or arrangement for extinguishing a fire with a firefighting medium or for cooling an object with a cooling medium, where the medium is produced from water and liquid nitrogen (or e.g. carbon dioxide). Similarly, the “method for extinguishing a fire with a firefighting medium produced from water and liquid nitrogen” is to be interpreted as a method for extinguishing a fire with a firefighting medium or for cooling an object with a cooling medium, where the medium is produced from water and liquid nitrogen (or e.g. carbon dioxide). It should further be noted that the reference to “at least 50 bar” is only an example of a suitable water pressure for providing a jet of firefighting/cooling medium, and regarding the proportion of liquid gas mixed into the jet of water it should be noted there are no specific limits.

The invention relates in general to an arrangement for generating a jet of a medium comprising water and nitrogen or carbon dioxide, wherein the arrangement comprises a mixing device for mixing incoming flows of pressurized water and liquid nitrogen or liquid carbon dioxide, said mixing device comprising: a nitrogen chamber provided with an inlet for feeding liquid nitrogen or carbon dioxide into the nitrogen chamber and an outlet allowing fluids to exit the nitrogen chamber; and a water guiding pipe provided with a nozzle at an end portion thereof. The nozzle is arranged to produce a jet of pressurized water when pressurized water is fed through the water guiding pipe. The water guiding pipe extends inside the nitrogen chamber along a central region thereof so as to be surrounded by nitrogen or carbon dioxide when present in the nitrogen chamber. The nozzle is located inside or in association with the nitrogen chamber outlet so that the jet of pressurized water mixes with and entrains nitrogen or carbon dioxide and forms the jet of the medium comprising water and nitrogen or carbon dioxide when pressurized water is fed through the water guiding pipe and when liquid nitrogen or liquid carbon dioxide is fed to the nitrogen chamber.

Liquid nitrogen is a suitable substance for use in the present invention. The term nitrogen chamber is used to denote a chamber suitable for being filled with nitrogen, and this term is used in this disclosure also in the case where carbon dioxide (CO₂) is fed to the chamber and used to generate the mixed medium jet. What is said below about nitrogen generally holds also for carbon dioxide.

When the jet of water is forced through nitrogen or carbon dioxide present in the nitrogen chamber, and typically present in a relatively high concentration also at some limited distance outside of the outlet of the chamber, the water mixes with and entrains nitrogen (or CO₂) and forms the jet of the medium comprising water and nitrogen (or CO₂). An advantage of passing the water jet through the liquid gas, compared to an opposite approach where liquid gas is injected or in other ways inserted into the water jet, is that the water jet is hold together and provides for a longer throw distance. Injecting gas into the water jet typically splits the jet and forms a mist. Such mist-formation could be useful in some applications but to form a jet that is useful for cooling or firefighting at longer distances the principle of the present invention is preferred.

A special feature of the above arrangement is that the water guiding pipe extends inside the nitrogen chamber along a central region thereof so as to be surrounded by nitrogen or carbon dioxide when present in the nitrogen chamber. A central positioning of the water guiding pipe, or rather of the nozzle arranged on the pipe, is advantageous in that it reduces the risk that water hits cold walls in the nitrogen chamber and forms ice, which could block the chamber. Further, since the water guiding pipe extends inside the nitrogen chamber it will be significantly cooled by the liquid gas and also the water flowing through the pipe will be significantly cooled before being discharged at the nozzle. An advantageous effect of this water cooling is that it reduces the evaporation of the liquid gas coming into contact with the water, which in turn provides for keeping the jet together (less diffusion of the jet stream, smaller jet diameter, longer throw distance).

In an embodiment, the nozzle is located inside the nitrogen chamber and arranged to direct the jet of pressurized water towards the nitrogen chamber outlet. The longer the distance between the nozzle and the outlet, the larger the amount of nitrogen (or carbon dioxide) that will interact with the water jet leaving the nozzle. Moreover, useful pressure conditions are generated in the chamber when the nozzle is located inside the chamber, i.e. the water jet creates a suction pressure that increases the flow velocity of the nitrogen through the chamber and sometimes also the mass flow rate of nitrogen. As a result, the amount of nitrogen mixed into the water/nitrogen jet increases. However, increasing the distance between the nozzle and the outlet also increases the risk of spraying water onto the cold walls of the chamber, which, as mentioned above, could block the chamber. The nozzle should therefore preferably be located relatively close to the outlet.

In an embodiment, a distance between the nozzle and the nitrogen chamber outlet is less than an inner diameter of the nitrogen chamber. As an example, if the nitrogen chamber has the shape of a circular cylinder with an inner diameter of 30 mm, the distance between the nozzle and the outlet should be less than 30 mm. In some embodiments a suitable distance between the nozzle and the nitrogen chamber outlet is approximately 50% of the inner diameter of the chamber, for instance 10-20 mm if the diameter is 30 mm. If the cross section of the nitrogen chamber varies along its length, one may relate the distance between the nozzle and the outlet to the diameter of the chamber at the outlet thereof. So if the chamber, for instance, includes a funnel-shaped part where the inner diameter increases at the outlet, the nozzle may be located further away from the outlet than if the chamber had no funnel-shape but a constant diameter. Exactly how to position the nozzle depends e.g. on the specific design of the nitrogen chamber and the nozzle, and on the water pressure intended to be used.

In an embodiment, a distance between the nozzle and the nitrogen chamber outlet is more than 10% of an inner diameter of the nitrogen chamber. As indicated above, this distance may be much more than 10% of the diameter.

In an embodiment, the nitrogen chamber has an elongated shape. This provides for letting the water guiding pipe extend inside and along the chamber, and liquid nitrogen can flow along the pipe at the outside thereof.

In an embodiment, the nitrogen chamber outlet is located in a first end portion of the nitrogen chamber and the nitrogen chamber inlet is located in a second end portion of the nitrogen chamber opposite to the first end portion. The nitrogen is thereby forced to flow along the water guiding pipe.

In an embodiment, the nitrogen chamber has a bent part and a straight part, wherein the water guiding pipe is straight and enters the nitrogen chamber through a wall of the nitrogen chamber in the bent part thereof, and wherein the water guiding pipe extends along the straight part of the nitrogen chamber. Although other variants are possible, this is a suitable way of designing the mixing device.

In an embodiment, the arrangement comprises a water supply connected to the water guiding pipe, wherein the water supply is configured to provide pressurized water at a pressure of at least 5 bar, or at least 10 bar, or at least 20 bar, or at least 30 bar, or at least 40 bar, or at least 50 bar. One or more displacement pumps may be used to obtain the desired pressure. What water pressure to use depends on the intended application of the arrangement and on, for instance, the specific design of the nozzle and the nitrogen chamber. Also higher pressures, such as 70 bar and more, may be used. An increased pressure generally leads to a longer throw distance for the mixed medium jet.

In an embodiment, the arrangement comprises a supply of liquid nitrogen, or liquid carbon dioxide, connected to the nitrogen chamber inlet. The pressure of the supply of liquid gas does not have to be high since it is the pressurized water that forms the jet stream. A sufficient nitrogen pressure may be a pressure sufficient to feed nitrogen from a liquid nitrogen tank and keep the nitrogen chamber filled with nitrogen. The above mentioned suction pressure generated by the water jet can be used to provide or increase the flow of nitrogen to the nitrogen chamber. When it in this disclosure is referred to liquid nitrogen it is generally meant that the supply of nitrogen is liquid nitrogen, i.e. the supply does not contain (only) pressurized gaseous nitrogen. When the nitrogen flows from the supply into, through and out from the nitrogen chamber, it may be in solid, liquid and/or gaseous form.

In an embodiment, the arrangement comprises one or more regulators for regulating a mass flow rate of pressurized water and/or of liquid nitrogen or carbon dioxide to the mixing device. This provides for varying the relative proportions of water and nitrogen/CO₂ in the mixed jet. Depending on the situation, different proportions may be desired. Preferably both mass flow rates can be regulated. In one example, it might be desired to use only nitrogen/CO₂, for instance when there is a fire in electric equipment and it is possible to come close to the fire. In this example, the water can be turned off. In another example, it might be desired to use only water, i.e. the water jet. In that example the flow of nitrogen can be turned off. In addition to these two extreme examples, it is possible to vary the proportions as desired. For instance, the mass flow rate can be the same for water and nitrogen. This means the mass flow rates through the outlet of the nitrogen chamber also will be the same but not necessarily the same in the mixed jet as it is difficult to control exactly how much nitrogen will not mix with the water but instead escape outside of the nitrogen chamber.

In an embodiment, the mixing device is moveable or at least rotatable so as to allow directing the medium jet in different directions. The mixing device may be intended to be handheld with hoses connected to the supplies of water and nitrogen so as to allow movability. The mixing device may alternatively be arranged in a stationary manner with the intended path of the medium jet pre-set in a certain direction, such as in a sprinkler system.

The invention also relates to a method for operating an arrangement according to above, the method comprising: feeding pressurized water to the water guiding pipe, and/or feeding liquid nitrogen or liquid carbon dioxide to the nitrogen chamber inlet. That is, the arrangement may be used to generate an outflow of nitrogen or carbon dioxide only, a water jet outflow only, or a jet of a medium comprising water and nitrogen/CO₂ (in different proportions).

In an embodiment, the method further comprises simultaneously feeding pressurized water to the water guiding pipe and feeding liquid nitrogen to the nitrogen chamber inlet so as to generate the jet of the medium comprising water and nitrogen.

In an embodiment of the method where the arrangement comprises mass flow rate regulators according to above, the method further comprises adjusting the one or more regulators for regulating the mass flow rate of pressurized water and/or of liquid nitrogen to the mixing device so as to adjust the relative proportions of water and nitrogen in the medium jet.

In an embodiment of the method, liquid nitrogen is fed to the nitrogen chamber inlet.

### BRIEF DESCRIPTION OF THE DRAWINGS

In the following, the present invention will be described by means of a number of different embodiments with reference to the accompanying drawings, in which:

FIG. 1 is a schematic view of a fire extinguisher/mixing device according to a first embodiment;

FIG. 2 is a schematic view of a fire extinguisher/mixing device according to a second embodiment; and

FIG. 3 is a schematic view of a mixing device according to a third embodiment.

### DESCRIPTION OF EMBODIMENTS OF THE INVENTION

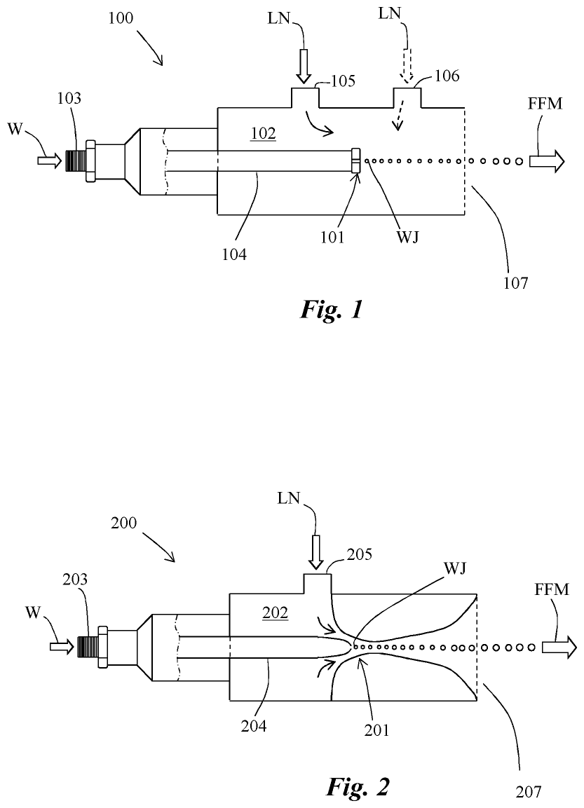

FIG. 1 is a schematic side view, partially in cross-section, of a fire extinguisher 100 according to a first embodiment of the invention. The fire extinguisher 100 is designed for producing a firefighting medium from water W and liquid nitrogen LN. Furthermore, the fire extinguisher 100 is designed to be used for extinguishing a fire, with the firefighting medium produced from water W and liquid nitrogen LN.

FIG. 2 is also a schematic side view, partially in cross-section, but of a fire extinguisher 200 according to a second embodiment of the invention. The fire extinguisher 200 according to the second embodiment is also designed for producing a firefighting medium from water W and liquid nitrogen LN. Furthermore, also the fire extinguisher 200 according to the second embodiment is designed to be used for extinguishing a fire, with the firefighting medium produced from water W and liquid nitrogen LN.

In the following, a method for producing a firefighting medium will be described with reference to both FIGS. 1 and 2.

The method is designed for producing a firefighting medium from water W and liquid nitrogen LN. The firefighting medium FFM is in this case produced by spraying a pressurized jet of water WJ out of a nozzle 101; 201 at a pressure of at least 50 bar and mixing a proportion of liquid nitrogen LN into the jet of water WJ. The jet of water WJ is preferably pressurized to the pressure of at least 50 bar by using one or several displacement pumps.

The proportion of nitrogen to water may be greater than 50 wt-% when producing the firefighting medium FFM. If the weight proportion of nitrogen is too low, the amount of ice crystals or particles produced in the firefighting medium may be insufficient to allow the firefighting medium to fly far enough to reach the seat of fire and deliver the water without it evaporating on the way. However, in other situations it may be desired to use a smaller proportion of nitrogen.

A surface tension reducing agent may be added to the water W sprayed out of the nozzle 101; 201 before mixing liquid nitrogen into the pressurized jet of water WJ. The addition of such a surface tension reducing agent may facilitate the formation of a cold foam which can further improve the extinguishing efficiency of the produced firefighting medium.

The mixing of liquid nitrogen into water is achieved in that the pressurized jet of water WJ entrains and mixes liquid nitrogen into itself while passing through a nitrogen chamber 102; 202.

In an embodiment of the method for producing a firefighting medium according to the invention, water from a water connection 103; 203 is fed to the nozzle 101; 201 via a pipe 104; 204 passing through the nitrogen chamber 102; 202, wherein nitrogen residing in the nitrogen chamber cools the water being fed through the pipe.

In an embodiment of the method for producing a firefighting medium according to the invention, the pressurized jet of water WJ is formed by feeding water from the water connection 203 into the converging end of a conical convergent-divergent nozzle 201, preferably a Laval nozzle.

In an embodiment of the method for producing a firefighting medium according to the invention, the pressurized jet of water WJ is directed such that it flows close to an orifice 105, 106; 205 connected to a tank with liquid nitrogen.

In the following, a fire extinguisher/mixing device according to the invention will be described with reference to both FIGS. 1 and 2.

The fire extinguisher 100; 200 is designed for extinguishing a fire with a firefighting medium produced from water W and liquid nitrogen LN. According to the invention, the fire extinguisher comprises fire extinguishing means adapted to allow it to extinguish the fire by directing a jet of a firefighting medium FFM produced by the method for producing a firefighting medium according to the invention onto the fire.

The fire extinguishing means preferably comprise a nozzle 101; 201 adapted for mixing liquid nitrogen LN into a water jet WJ at a high pressure. In a particularly advantageous embodiment, the fire extinguishing means comprise a directable nozzle 101; 201 for discharging the jet of firefighting medium FFM in a direction toward the fire. Preferably, the fire extinguishing means comprise an internal water tank or a connection to an external water supply. Particularly preferably, the fire extinguishing means comprise an internal pressure tank with liquid nitrogen or a connection 105, 106; 205 to an external source of liquid nitrogen.

The fire extinguisher can be designed as a hand-held fire extinguisher, as a mobile fire extinguisher, or as a stationary fire extinguisher. Particularly advantageously, the fire extinguisher according to the invention can be designed as an automatic fire extinguisher for use in battery factories and other applications with high fire risk.

In the following, a method for extinguishing a fire according to the invention will be described with reference to both FIGS. 1 and 2.

The method is designed for extinguishing a fire with a firefighting medium produced from water W and liquid nitrogen LN. The fire is extinguished by directing a jet of a firefighting medium FFM produced by the method for producing a firefighting medium onto the fire.

In an embodiment of the method, the jet of firefighting medium FFM cools down the fire and excludes oxygen therefrom.

In an embodiment of the method, water in the jet of firefighting medium FFM freezes to ice crystals or particles which increase the effective extinguishing distance of the jet of firefighting medium.

In an embodiment of the method for extinguishing a fire according to the invention, a surface tension reducing agent added to the firefighting medium FFM causes it to form a cold foam comprising nitrogen gas and ice crystals which improve the extinguishing efficiency of said firefighting medium.

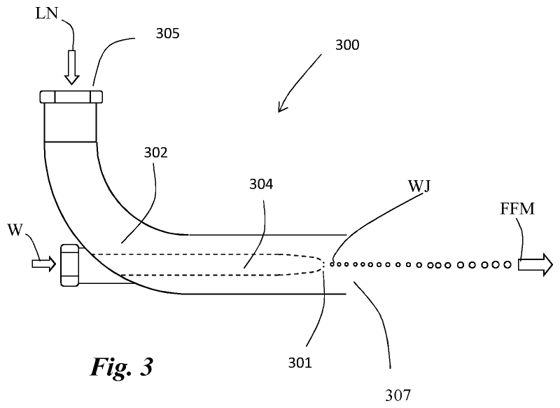

FIG. 3 shows a mixing device 300 for mixing incoming flows of pressurized water W and liquid nitrogen LN. The mixing device 300 forms part of an arrangement for generating a jet of a medium FFM comprising water and nitrogen suitable for use in firefighting or for efficient cooling of objects. FIGS. 1 and 2 show other variants of mixing devices 100, 200.

The mixing device 300 comprises a nitrogen chamber 302 provided with an inlet 305 for feeding liquid nitrogen into the nitrogen chamber 302 and an outlet 307 arranged in a first end portion of the nitrogen chamber 302 allowing fluids to exit the nitrogen chamber 302, such as the mixed medium jet FFM. The nitrogen chamber 302 has an elongated shape and in this example the nitrogen chamber inlet 305 is located in a second end portion of the nitrogen chamber 302 opposite to the first end portion so that nitrogen fed into the chamber via inlet 305 flows in a longitudinal direction of the chamber 302 towards the outlet 307.

The mixing device further comprises a water guiding pipe 304 provided with a nozzle 301 at an end portion thereof. The nozzle 301 is arranged to produce a jet of pressurized water WJ when pressurized water is fed through the water guiding pipe 304. The nozzle 301 may be a circular opening at the end of the pipe 304. The water guiding pipe 304 extends inside the nitrogen chamber 302 along a central region thereof so as to be surrounded by nitrogen when nitrogen is present in the nitrogen chamber 302. This way, the pipe 304 and the water therein becomes cooled by the nitrogen before discharge through nozzle 301.

In the example shown in FIG. 3, the nitrogen chamber 302 has a bent part and a straight part. The water guiding pipe 304 is straight and enters the nitrogen chamber 302 through a wall of the nitrogen chamber 302 in the bent part thereof, and the water guiding pipe 304 extends along the straight part of the nitrogen chamber 302.

The nozzle 301 is located inside the nitrogen chamber 302 and arranged to direct the jet of pressurized water WJ towards the nitrogen chamber outlet 307. The jet of pressurized water WJ will thus mix with and entrain nitrogen and form the jet of the medium FFM comprising water and nitrogen when pressurized water is fed through the water guiding pipe 304 and when liquid nitrogen LN is fed to the nitrogen chamber 302.

A distance in the longitudinal direction of the nitrogen chamber 302 between the nozzle 301 and the nitrogen chamber outlet 307 is in this example approximately 50% of an inner cross-sectional diameter of the nitrogen chamber 302.

As an example of dimensions, the pipe 304 may have a length of around 80 mm inside the nitrogen chamber 302, the diameter of the pipe 304 may be 7 mm (converging to around 5 mm at the end), and the nozzle hole may have a diameter of 2 mm. The nitrogen chamber 302 may have a length from inlet 305 to outlet 307 of around 150 mm and a circular cross section with an inner diameter of 14 mm. The distance between the nozzle 301 and the nitrogen chamber outlet 307 may be ca 7-8 mm. If this distance is increased too much, water will hit the walls of the chamber 302, form ice and block the chamber 302. If this distance is decreased too much, the water jet induced suction pressure will decrease and less nitrogen will mix into the water jet WJ. These exemplified dimensions may be changed, e.g. scaled-up, depending on the application.

The arrangement for generating the mixed jet FFM further comprises a water supply (not shown) connected to the water guiding pipe 304. The water supply may include one or more pumps and provide pressurized water W at a suitable pressure. As examples, 10 bar may be suitable for a first application, 30 bar in a second application, 50 bar in a third application and 70 bar in a fourth application. A certain arrangement may have a water supply with pre-set water pressure. Alternatively, the water pressure may be adjustable.

The arrangement further comprises a supply of liquid nitrogen (not shown) connected to the nitrogen chamber inlet 205.

The arrangement further comprises regulators (not shown) for regulating a mass flow rate of pressurized water W and of liquid nitrogen LN to the mixing device 300. This makes it possible to regulate the relative proportion of water and nitrogen in the mixed jet FFM.

The fire extinguishers/mixing devices shown in FIGS. 1 and 2 are structured and function in a similar way as the mixing device shown in FIG. 3.

A method for operating an arrangement provided with a mixing device 100, 200, 300 according to above comprises:
feeding pressurized water W to the water guiding pipe 104, 204, 304, and/or
feeding liquid nitrogen LN to the nitrogen chamber inlet 105, 106, 205.

Accordingly, the arrangement may be used to discharge only nitrogen, only pressurized water WJ, or a mixed jet FFM containing both water and nitrogen through the outlet 107, 207, 307.

Typically, the method includes also:
simultaneously feeding pressurized water W to the water guiding pipe 104, 204, 304 and feeding liquid nitrogen LN to the nitrogen chamber inlet 105, 106, 205, 305 so as to generate the jet of the medium FFM comprising water and nitrogen.

The method may also include:
adjusting the regulators for regulating the mass flow rate of pressurized water W and of liquid nitrogen LN to the mixing device 100, 200, 300 so as to adjust the relative proportions of water and nitrogen in the medium jet FFM.

In the foregoing, the present invention has been described with the aid of a number of different embodiments and with reference to the accompanying drawings. It should be understood, however, that the invention is not limited to the described embodiments and to what is shown in the drawings, but that also other embodiments are conceivable within the scope of the invention as it is defined by the following claims.

1. A method for producing a firefighting medium from water (W) and a liquid gas, such as liquid nitrogen (LN) or liquid carbon dioxide, characterized in that said firefighting medium (FFM) is produced by spraying a pressurized jet of water (WJ) out of a nozzle (101; 201; 301) at a pressure of, for instance, at least 50 bar and mixing a proportion of liquid gas into said jet of water (WJ).

2. The method according to claim 1,
characterized in that the proportion of liquid gas to water is greater than 50 wt-% when producing said firefighting medium (FFM).

3. The method according to claim 1,
characterized in that a surface tension reducing agent is added to the water (W) sprayed out of said nozzle (101; 201; 301) before mixing liquid gas into said pressurized jet of water (WJ).

4. The method according claim 1,
characterized in that said mixing is achieved in that said pressurized jet of water (WJ) entrains and mixes liquid gas into itself while passing through a nitrogen chamber (102; 202; 302).

5. The method according to claim 4,
characterized in that water from a water connection (103; 203) is fed to said nozzle (101; 201; 301) via a pipe (104; 204; 304) passing through said nitrogen chamber (102; 202), wherein liquid gas residing in said nitrogen chamber cools said water being fed through said pipe.

6. The method according to claim 5,
characterized in that said pressurized jet of water (WJ) is formed by feeding water from said water connection (203) into the converging end of a conical convergent-divergent nozzle (201).

7. The method according to claim 1,
characterized in that said pressurized jet of water (WJ) is directed such that it flows close to an orifice (105, 106; 205) connected to a tank with liquid gas.

8. The method according to claim 1,
characterized in that said jet of water (WJ) is pressurized to a pressure of at least 50 bar by using one or several displacement pumps.

9. A fire extinguisher (100; 200; 300), for extinguishing a fire with a firefighting medium produced from water (W) and liquid gas, such as liquid nitrogen (LN) or liquid carbon dioxide, characterized in that said fire extinguisher comprises fire extinguishing means adapted to allow it to extinguish said fire by directing a jet of a firefighting medium (FFM) produced by the method according to claim 1 onto said fire.

10. The fire extinguisher (100; 200; 300) according to claim 9, characterized in that said fire extinguishing means comprise a directable nozzle (101; 201; 301) for discharging said jet of firefighting medium (FFM) in a direction toward said fire.

11. The fire extinguisher (100; 200; 300) according to claim 9, characterized in that said fire extinguishing means comprise a nozzle (101; 201; 301) adapted for mixing liquid nitrogen (LN) or other liquid gas into a water jet (WJ) at a high pressure.

12. The fire extinguisher according to claim 9, characterized in that said fire extinguishing means comprise an internal pressure tank with liquid gas or a connection (105, 106; 205) to an external source of liquid gas.

13. A method for extinguishing a fire, with a firefighting medium produced from water (W) and liquid gas, such as liquid nitrogen (LN) or liquid carbon dioxide, characterized in that said fire is extinguished by directing a jet of a firefighting medium (FFM) produced by the method claim 1 onto said fire.

14. The method for extinguishing a fire according to claim 13, characterized in that said jet of firefighting medium (FFM) cools down said fire and excludes oxygen therefrom.

15. The method for extinguishing a fire according to claim 13, characterized in that water in said jet of firefighting medium (FFM) freezes to ice crystals or particles which increase the effective extinguishing distance of said jet of firefighting medium.

16. The method for extinguishing a fire according claim 13, characterized in that a surface tension reducing agent added to said firefighting medium (FFM) causes it to form a cold foam comprising nitrogen or carbon dioxide gas and ice crystals which improve the extinguishing efficiency of said firefighting medium.

17. An arrangement for generating a jet of a medium (FFM) comprising water and nitrogen or carbon dioxide, wherein the arrangement comprises a mixing device (100, 200, 300) for mixing incoming flows of pressurized water (W) and liquid nitrogen (LN) or liquid carbon dioxide, said mixing device (100, 200, 300) comprising:
a nitrogen chamber (102, 202, 302) provided with an inlet (105, 106, 205, 305) for feeding liquid nitrogen or carbon dioxide into the nitrogen chamber (102, 202, 302) and an outlet (107, 207, 307) allowing fluids to exit the nitrogen chamber (102, 202, 302);
a water guiding pipe (104, 204, 304) provided with a nozzle (101, 201, 301) at an end portion thereof,
wherein the nozzle (101, 201, 301) is arranged to produce a jet of pressurized water (WJ) when pressurized water is fed through the water guiding pipe (104, 204, 304);
wherein the water guiding pipe (104, 204, 304) extends inside the nitrogen chamber (102, 202, 302) along a central region thereof so as to be surrounded by nitrogen or carbon dioxide when nitrogen or carbon dioxide is present in the nitrogen chamber (102, 202, 302), wherein the nozzle (101, 201, 301) is located inside or in association with the nitrogen chamber outlet (107, 207, 307) so that the jet of pressurized water (WJ) mixes with and entrains nitrogen or carbon dioxide and forms the jet of the medium (FFM) comprising water and nitrogen or carbon dioxide when pressurized water is fed through the water guiding pipe (104, 204, 304) and when liquid nitrogen (LN) or liquid carbon dioxide is fed to the nitrogen chamber (102, 202, 302).

18. The arrangement according to claim 17, wherein the nozzle (101, 201, 301) is located inside the nitrogen chamber (102, 202, 302) and arranged to direct the jet of pressurized water (WJ) towards the nitrogen chamber outlet (107, 207, 307).

19. The arrangement according to claim 18, wherein a distance between the nozzle (101, 201, 301) and the nitrogen chamber outlet (107, 207, 307) is less than an inner diameter of the nitrogen chamber (102, 202, 302).

20. The arrangement according to claim 18, wherein a distance between the nozzle (101, 201, 301) and the nitrogen chamber outlet (107, 207, 307) is more than 10% of an inner diameter of the nitrogen chamber (102, 202, 302).

21. The arrangement according to claim 17, wherein the nitrogen chamber (102, 202, 302) has an elongated shape.

22. The arrangement according to claim 17, wherein the nitrogen chamber outlet (107, 207, 307) is located in a first end portion of the nitrogen chamber (102, 202, 302) and wherein the nitrogen chamber inlet (105, 106, 205, 305) is located in a second end portion of the nitrogen chamber (102, 202, 302) opposite to the first end portion.

23. The arrangement according to claim 17, wherein the nitrogen chamber (102, 202, 302) has a bent part and a straight part, wherein the water guiding pipe (104, 204, 304) is straight and enters the nitrogen chamber (102, 202, 302) through a wall of the nitrogen chamber (102, 202, 302) in the bent part thereof, and wherein the water guiding pipe (104, 204, 304) extends along the straight part of the nitrogen chamber (102, 202, 302).

24. The arrangement according to claim 17, wherein the arrangement comprises a water supply connected to the water guiding pipe (104, 204, 304), wherein the water supply is configured to provide pressurized water (W) at a pressure of at least 5 bar, or at least 10 bar, or at least 20 bar, or at least 30 bar, or at least 40 bar, or at least 50 bar.

25. The arrangement according to claim 17, wherein the arrangement comprises a supply of liquid nitrogen or liquid carbon dioxide connected to the nitrogen chamber inlet (105, 106, 205).

26. The arrangement according to claim 24, wherein the arrangement comprises one or more regulators for regulating a mass flow rate of pressurized water (W) and/or of liquid nitrogen (LN) or carbon dioxide to the mixing device (100, 200, 300).

27. The arrangement according to claim 17, wherein the mixing device (100, 200, 300) is moveable or at least rotatable so as to allow directing the medium jet (FFM) in different directions.

28. A method for operating an arrangement according to claim 17, the method comprising:
feeding pressurized water (W) to the water guiding pipe (104, 204, 304), and/or
feeding liquid nitrogen (LN) or liquid carbon dioxide to the nitrogen chamber inlet (105, 106, 205).

29. The method according to claim 28, further comprising:
simultaneously feeding pressurized water (W) to the water guiding pipe (104, 204, 304) and feeding liquid nitrogen (LN) or liquid carbon dioxide to the nitrogen chamber inlet (105, 106, 205) so as to generate the jet of the medium (FFM) comprising water and nitrogen or carbon dioxide.

30. The method according to claim 29, the method comprising:
adjusting the one or more regulators for regulating the mass flow rate of pressurized water (W) and/or of liquid nitrogen (LN) or liquid carbon dioxide to the mixing device (100, 200, 300) so as to adjust the relative proportions of water and nitrogen or carbon dioxide in the medium jet (FFM).

31. The method according to claim 29, wherein liquid nitrogen (LN) is fed to the nitrogen chamber inlet (105, 106, 205).
